(19) United States
(12) Patent Application Publication
(10) Pub. No.: US 2013/0173348 A1
(43) Pub. Date: Jul. 4, 2013

(54) FRAMEWORK TO RENDER SPATIAL INFORMATION OF ENTITIES

(71) Applicant: VANDANA DEEP, Union City, CA (US)

(72) Inventor: VANDANA DEEP, Union City, CA (US)

(21) Appl. No.: 13/339,391

(22) Filed: Dec. 29, 2011

(51) Int. Cl. G06Q 10/06

(52) U.S. Cl. 705/7.36

(57) ABSTRACT

In an embodiment, the spatial information of the business entities are captured and transformed to corresponding spatial coordinates. The spatial coordinates include positional values of the business entities at various instances of time. Based upon a business condition configured for the business entities, the spatial coordinates are processed to compute a deviation between positional values of the spatial coordinates and values specified in the business condition. Based upon the deviation, a correlation between a business logic associated with the business entities and the spatial coordinates is determined. A comparative analysis of the correlation is executed for the spatial coordinates and the associated time instances. Based upon the analysis, the framework is generated to render a visual representation of the spatial information, to establish a business decision.

### FIELD

The field generally relates to computer systems and software, and more particularly to methods and systems to generate a framework to render spatial information of entities in an enterprise.

### BACKGROUND

In business environments, tracking and recording the movements of various business entities within a place of business may be important to determine business decisions.

### SUMMARY

Various embodiments of systems and methods to generate a framework to render spatial information of business entities in an enterprise are disclosed. Representing the spatial information of moving business entities in a perceivable manner may be useful to establish real-time business decisions in enterprise resource planning systems. To represent the spatial information in such a perceivable manner, an analysis of the spatial information is necessary. To achieve this, the spatial information of the moving business entities is captured. Capturing the spatial information may include capturing the movement of business entities in various areas of a business facility at various instances, capturing a pattern of change in location of the business entities and the like. Spatial information includes movement and location information of people, business-resources, RFID tagged items, hand-held devices, satellite navigation enabled devices, global positioning systems, cell phone devices, and the like. A person skilled in the relevant art will recognize various other entities whose spatial information may be captured for relevant business purposes.

The captured spatial information of the business entities are transformed into spatial coordinates. The spatial coordinates include statistical representation of location and movement of business entities, and include positional values corresponding to the location and movement of the business entities. In an embodiment, business conditions are configured for the business entities and the business enterprise in which they exist. In an embodiment, business conditions include parameters that influence the operation and performance of a business. Based upon the configured business conditions, the spatial coordinates are processed to compute a deviation of the spatial coordinates from the business conditions. The deviation may be computed by comparing the positional values of the spatial coordinates and values associated with the business conditions.

Based upon the deviation, a correlation between a business logic associated with the business entities and the spatial coordinates is determined. A comparative analysis of the spatial coordinates is executed based upon the correlation, to render a visual representation of the correlation between the business logic and the spatial coordinates. Based upon the comparative analysis, the visual representation of the spatial information of the business entities is rendered on a computer generated user interface. The visual representation of the spatial information may be utilized to establish business decisions based upon the location and movement of business entities.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating an overview of a system to generate a visual representation of spatial information of business entities in an enterprise, according to an embodiment.

FIG. 2 is a process flow diagram illustrating a method to generate a visual representation of spatial information of business entities in an enterprise, according to an embodiment.

FIG. 3A is a graphical user interface illustrating a method to generate a visual representation of spatial information of business entities in an enterprise, according to an embodiment.

FIGS. 3B and 3C illustrate the visual representation generated on the graphical user interface, according to an embodiment.

FIG. 4 is a block diagram illustrating a computer system to generate a visual representation of spatial information of business entities in an enterprise, according to an embodiment.

FIG. 5 is a block diagram illustrating an exemplary computer system, according to an embodiment.

### DETAILED DESCRIPTION

Embodiments of techniques for systems and methods to generate framework to render spatial information of business entities in an enterprise are disclosed. Representation of spatial information in a perceivable manner may be used to establish business decisions to suit a business need of the enterprise. To generate the framework, the spatial information of the business entities is captured. Capturing the spatial information includes observing the movement of business entities over time, and providing a timely sequence of movement and location data. In an embodiment, a correlation framework is constructed to determine a correlation between the spatial information and business conditions configured for the business entities. Based upon associated business logic, the correlation framework analyzes the correlation and generates the visual representation of the spatial information to establish the business decisions.

In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

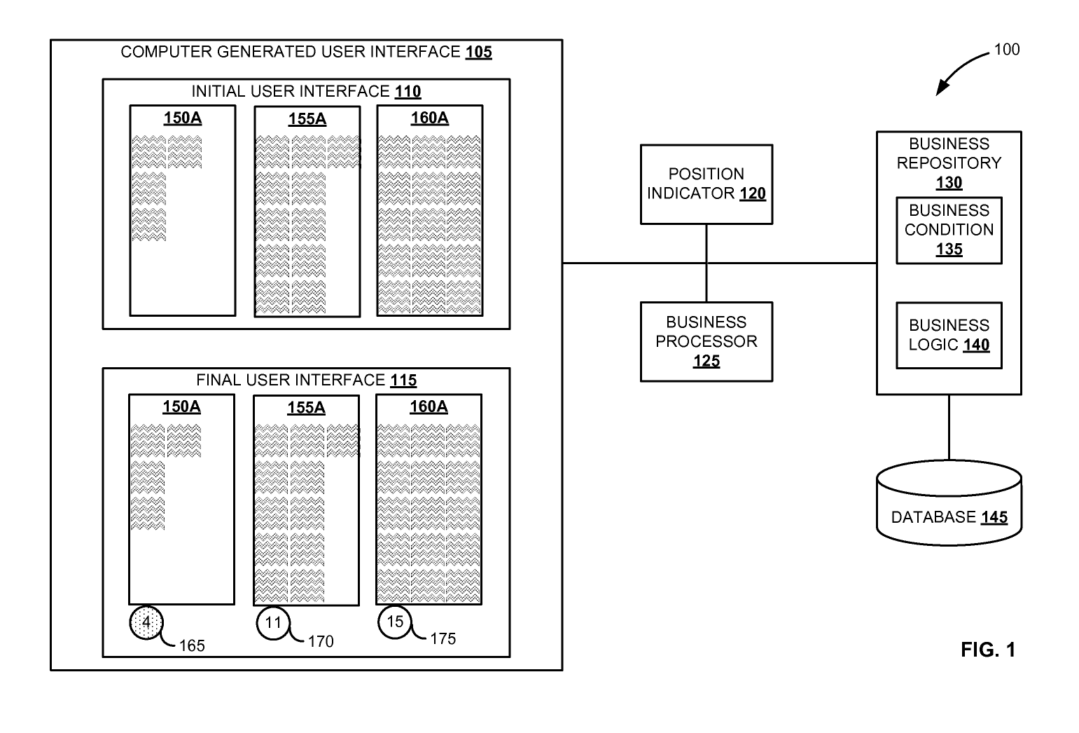

FIG. 1 is a block diagram illustrating an overview of a system to generate a visual representation of spatial information of business entities in an enterprise, according to an embodiment. An enterprise may include an undertaking or a system whose purpose is extraction, production or distribution of goods or provision of services. It is an association of various resources that work towards achieving a common goal. Some examples of an enterprise include a retail store, a hospital, a warehouse, a factory, and the like. The resources may include, but are not limited to, store-staff, store-items, customers and the like for the retail store; patients, doctors, medicines, medical-staff and the like for the hospital; and so on. These resources may also be referred to as business entities that are orchestrated to achieve the common goal of the enterprise. For executing the purpose of the enterprise, the business entities may be in motion. Hence there is a change of location and a movement of the business entities, and this change occur continuously or at intervals. In an embodiment, spatial information includes the location and movement information of any entity. To achieve the goal of the enterprise, analyzing the spatial information provides efficient utilization of the business entities. For instance, if a medical emergency is detected in a hospital, an administrator may analyze the real-time spatial information of the doctors, and alert a relevant doctor to attend to the emergency.

In an embodiment, the business entities of an enterprise are administered and managed remotely by capturing the movement of the business entities and rendering it on a machine. For instance, the movement of the doctors in a hospital is administered and managed by an administrator by viewing their movement on a computer. To render the spatial information on a computer, the change of location and movement may be captured through a camera. Thus, the spatial information may be captured at real-time and displayed on a display-device. The captured spatial information may also be stored for future utilization. For instance, if a particular medicine is largely consumed in one day, an administrator orders for delivery of a larger stock of the medicine for a subsequent day. Here, the spatial information of the medicine is captured for the entire day and stored to make a business decision at a later time. Thus, representing the spatial information of moving business entities in a perceivable manner may be useful to establish real-time business decisions in enterprise resource planning systems.

The captured spatial information is transformed into spatial coordinates. According to an embodiment, the spatial coordinates are a statistical representation of the spatial information, and include the location and movement details of the business entities. The spatial coordinates indicate a set of measurements of each business entity and their association with a group of similar business entities. The spatial coordinates include positional values of the business entities at various instances of time. Transforming the spatial information into spatial coordinates include identifying a location and a movement of each business entity and generating a statistical representation of the location and the movement.

Metadata associated with the business entities and the enterprise is stored in a storage device, for instance a database. The metadata includes business conditions, business logic and any other information associated with the business entities and the enterprise in which they (business entities) exist. The business condition includes a set of rules that specify a requirement to be fulfilled to proceed with the execution of the purpose of the enterprise. Business condition also includes threshold and threshold drifts that indicate corresponding actions to be executed in the enterprise. The business logic may describe principles or algorithms to handle the business entities within the enterprise. Business logic may also include instructions to perform one or more functions associated with generating the visual representation.

The business condition and the business logic associated with the business entities are determined. Further, based upon the business conditions and the business logic, a correlation framework is generated to transform the spatial information into corresponding spatial coordinates; to compute a deviation between the spatial coordinates and the business condition, and based upon the deviation, to determine a correlation between the business logic and the spatial coordinates. Based upon the correlation, a comparative analysis is executed by examining the manner of deviation, and the relation and significance between the spatial coordinates and business entities. As a result of the comparative analysis, a set of business actions representing a type of action to be taken to negate the deviation are generated by the framework. The framework represents a business model that is generated to execute the procedures of calculating the deviation, determining the correlation and executing the comparative analysis; and to represent the spatial information of the business entities in an understandable, thereby real-time business decisions are established.

In an embodiment, the framework generates a graphical representation of a current instance or a current situation of the business entities in the enterprise along with the correlation between the spatial coordinates, the business condition and the business logic. The graphical representation may be a resultant of the comparative analysis. In an embodiment, a list of actions to be performed is generated based upon the comparative analysis. In another embodiment, a pictorial representation illustrating business entities or parts of the enterprise that needs immediate attention. The comparative analysis may be utilized to work out any divergence that may have occurred in the enterprise; to rectify any deviations between an ideal value defined by the enterprise and a practical value recorded in real-time; to monitor a real-time activity in an enterprise; and the like. Based upon the comparative analysis, the correlation framework renders a visual representation including the determined correlation, to establish the business decision.

In an embodiment, computer system 100 is used to provide a visual representation of the spatial information to make business decisions on real time information. Computer system 100 includes computer generated user interface (UI) 105, position indicator 120, business processor 125, business repository 130, business condition 135, business logic 140, and database 145. In an embodiment, computer generated UI 105 is in communication with position indicator 120 and business processor 125. Business processor 125 is in communication with business repository 130, which is further in communication with database 145. In an embodiment computer generated UI 105 renders initial user interface 110. Initial UI 110 includes the captured spatial information of the business entities in an enterprise. Elements 150A, 155A and 160A represent three business entities present in an enterprise.

A motion capturing device, for instance a camera, captures the real-time motion of the business entities in an enterprise, and renders the real-time motion on initial UI 110. Position indicator 120 captures the spatial information of the business entities from initial UI 110. For instance, position indicator 120 tracks the motion of business entities 150A, 155A and 160A rendered on initial UI 110, and captures their spatial information. In an embodiment, position indicator 120 captures real-time spatial information of the business entities and sends the spatial information for processing. Business processor 125 processes the spatial information and transforms the spatial information to corresponding spatial coordinates. Business processor 125 may store the spatial coordinates of the business entities in database 145 along with corresponding time-stamps. The time-stamps indicate a time at which the spatial information was captured. In an embodiment, at any given instance, a historical data set may be generated based upon the spatial information and the corresponding time-stamps stored in database 145. The historical data set may render the spatial information of the business entities over a period of time. In an embodiment, the spatial coordinates are mapped to corresponding business entities and rendered on user interface 105. In an embodiment, mapping the spatial coordinates may include representing the spatial coordinates as a graphical element on user interface 105.

For example, consider a medical storehouse that stores various medicines and monitors the flow of medicines in the storehouse. Consider that 150A represents a shelf of four cartons of medicine AAA, 155A represents a shelf of eleven cartons of medicine BBB and 160A represents a shelf of fifteen cartons of medicine CCC on a Monday morning at 07:00. A camera installed in the medical storehouse captures the real-time motion of the medicine cartons in the medical storehouse, and renders the real-time motion on initial UI 110. Position indicator 120 captures the spatial information from the rendered motion, including location and movement of the medicine cartons from one shelf to another, and sends this information for processing. Business processor 125 identifies the location and movement information from the captured spatial information of the cartons of medicines, and transforms the spatial information into spatial coordinates. Business processor 125 also associates a corresponding time-stamp to the location and movement included in the spatial information of the medicine cartons, and stores the spatial information along with the time-stamps in database 145. The spatial coordinates at 07:00 on Monday indicates the number of cartons of medicine AAA, medicine BBB and medicine CCC at their current locations. Consider an instance, wherein one carton of medicine AAA is moved from 150A to 155A on Monday at 08:45. The spatial coordinates at 08:45 on Monday indicate the number of cartons of medicine AAA at 150A as three cartons. The spatial coordinates also indicate the movement of one carton of medicine AAA from 150A to 155A. These measurements of the business entities may be described as positional values corresponding to the spatial coordinates.

Business repository 130 stores metadata associated with the business entities and the enterprise. Business condition 135 includes rules to determine a requirement to be accomplished to proceed with the execution of the purpose of the enterprise, for instance “INCREASE SUPPLY”, “INCREASE DISCOUNTS”, “DECREASE SUPPLY”, “INFORM SUPPLIER ABOUT SALES”, “INFORM SUPPLIER ABOUT COMPLAINTS” and the like. Business condition 135 may include threshold values indicating one or more associated actions to be executed based upon a deviation of the spatial information from the threshold value. For instance, consider a threshold value equal to 15; business condition 135 associated with the medical storehouse includes “INFORM SUPPLIER TO INCREASE SUPPLY” that needs to be executed when a medicine stock goes below fifteen quantities. Business condition 135 may also include threshold drifts indicating one or more actions to be executed immediately based upon a deviation of the spatial information from the threshold value. For instance, consider a threshold drift equal to 5; business condition 135 associated with the medical storehouse includes “ARRANGE FOR IMMEDIATE SUPPLY” that needs to be executed when a medicine stock goes below five quantities.

Business logic 140 includes procedures to handle the business entities, for instance, business actions to be taken for corresponding deviations that are computed based upon business conditions 135. For instance, for a deviation from the threshold value, a business action ‘INCREASE SUPPLY’ may be configured for a value higher than the threshold value; and a business action ‘DECREASE SUPPLY’ may be configured for a value lower than the threshold value. In an embodiment, business logic 140 includes the actions that are to be executed for the business conditions, and include the actions to be executed for deviation from threshold value and from threshold drift.

Business processor 125 identifies business condition 135 configured for the business entities by identifying the threshold values and the threshold drifts configured for the business entities. Further, business processor 125 compares the spatial coordinates with the business condition 135 by comparing the positional values associated with the spatial coordinates, with threshold values and threshold drifts associated with the business condition 135. Based upon the comparison, business processor 125 computes a deviation of the spatial coordinates from business condition 135. The computed deviation includes a difference between the positional values and the threshold values and/or threshold drifts associated with business condition 135. In an embodiment, user interface 105 may render a visual representation of the spatial coordinates and indicate the associated deviation. For instance, consider a threshold value ‘15’ and a threshold drift ‘5’; if the spatial coordinates correspond to four cartons of medicine AAA at 150A, business processor 125 compares the value ‘4’ of the spatial coordinates with the values ‘15’ and ‘5’ corresponding to the threshold and the threshold drift values. Business processor 125 indicates a deviation from the threshold value and the threshold drift as a threshold value (15)˜spatial coordinate (4)=11; and threshold drift value (50)˜spatial coordinate (4)=1.

Business processor 125 identifies the business logic 140 (e.g. principles or the business actions) corresponding to the associated with the business entities based upon the computed deviation. For instance, “INCREASE IN SUPPLY”, “ARRANGE FOR IMMEDIATE SUPPLY” and the like are identified. Based upon the deviation, business processor 125 determines a correlation between the identified business logic 140 and the spatial coordinates of the business entities by determining a relation between the spatial coordinates and the business entities; identifying a significance of the relation based upon the enterprise; and deriving a business scope for the spatial coordinates based upon the significance. In an embodiment, the derived relation includes a circumstance of the enterprise; the significance illustrates business needs; and the business scope includes procedures to accomplish the purpose of the enterprise. For instance, consider a threshold value ‘15’ and a threshold drift ‘5’ for medicine cartons AAA in medical storehouse. A relation between a spatial coordinate ‘4’; and a corresponding business entity medicine cartons AAA may describe that the available stock of the medicine AAA includes four cartons. A significance of this relation may describe that a deviation from the threshold value is ‘11’; and from the threshold drift is ‘1’. Hence, the stock of the medicine AAA is less than the threshold value and the threshold drift. A business scope for this significance may include instructions to take immediate action of arranging for increasing the stock of medicine AAA to reduce the deviation from the threshold drift; and to take a further action of increasing the stock of the medicine AAA to reduce the deviation from the threshold value. Further, the significance instructs that a supplier of medicine AAA needs to be informed about a trend of sales of medicine AAA to increase further supply to the medical storehouse.

A comparative analysis is executed by examining the manner of deviation, the relation and significance between the spatial coordinates and the business. As a result of the analysis, business processor generates business actions: ‘MONITOR AVAILABILITY OF STOCK; INCREASE STOCK OF MEDICINE X BY ‘6’ CARTONS IMMEDIATELY AND FURTHER BY ‘5’ CARTONS. Based upon the analysis, a correlation framework is created to render a visual representation of the spatial information of the business entities on user interface 105 to establish the business decisions ‘REFILL STOCK OF MEDICINE X IMMEDIATELY’, ‘REQUEST SUPPLIER TO INCREASE SUPPLY’ or the like. The visual representation of spatial information of the business entities includes representing the spatial information along with analysis elements. For instance final UI 115 includes element 165, 170 and 175 representing a number of the cartons present in each section of the enterprise along with a shaded portion indicating an immediate attention required; and thus illustrate the visual representation of the analysis in an understandable manner.

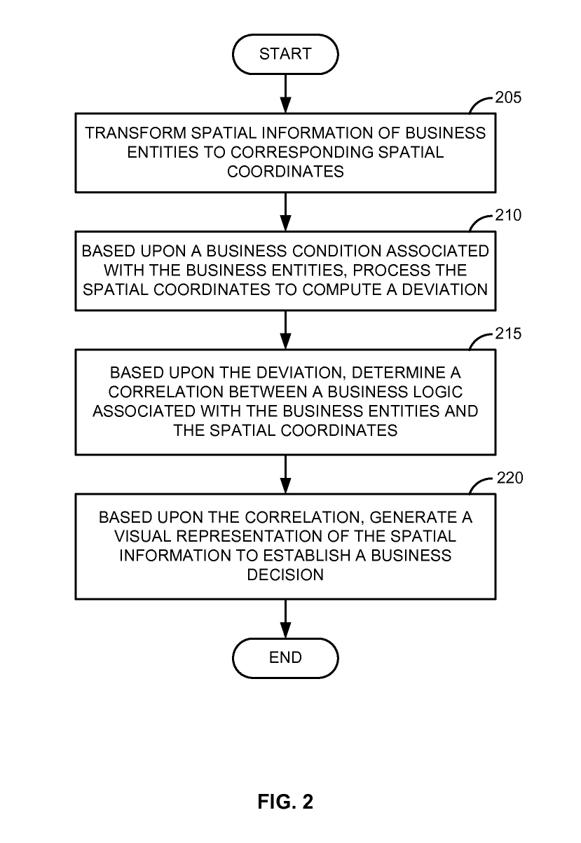

FIG. 2 is a process flow diagram illustrating a method to generate a visual representation of spatial information of business entities in an enterprise, according to an embodiment. In an embodiment, the spatial information of the business entities is captured. In process block 205, the spatial information is transformed to corresponding spatial coordinates. The spatial coordinates include positional values of the business entities at various instances of time. Transforming the spatial information into spatial coordinates includes identifying a location and movement of each business entity and generating a statistical representation. In process block 210, based upon a business condition configured in the business entities, the spatial coordinates are processed to compute a deviation. Processing the spatial coordinates includes identifying a positional value associated with each spatial coordinate and comparing the positional value with values associated with the business condition. The difference between the values associated with the business condition and the positional values associated with the spatial coordinate is represented as the deviation.

In process block 215, based upon the deviation, a correlation between a business logic associated with the business entities and the spatial coordinates is determined. In an embodiment, the business logic includes instructions to derive a relation between the spatial coordinates and the business entities, to identify a significance of the relation and to derive a business scope for the spatial coordinates. Determining the correlation may include determining the relation between the spatial coordinates and the business entities. A comparative analysis of the correlation is executed for the spatial coordinates and associated time instances of the spatial coordinates. Based upon the analysis of the correlation, in process block 220, a visual representation of the spatial information is generated to establish a business decision. A computer generated user interface may render the visual representation of the spatial information as a graphical representation of the spatial coordinates, and the correlation between the spatial coordinates. Representing the spatial information in a perceivable manner, such as a graphical representation or any visual representation, is useful to establish business decisions in enterprises. Since the spatial information is being represented visually, a real-time business decision may be established; and by recording the spatial information for a period of time, various other types of business decisions may be established.

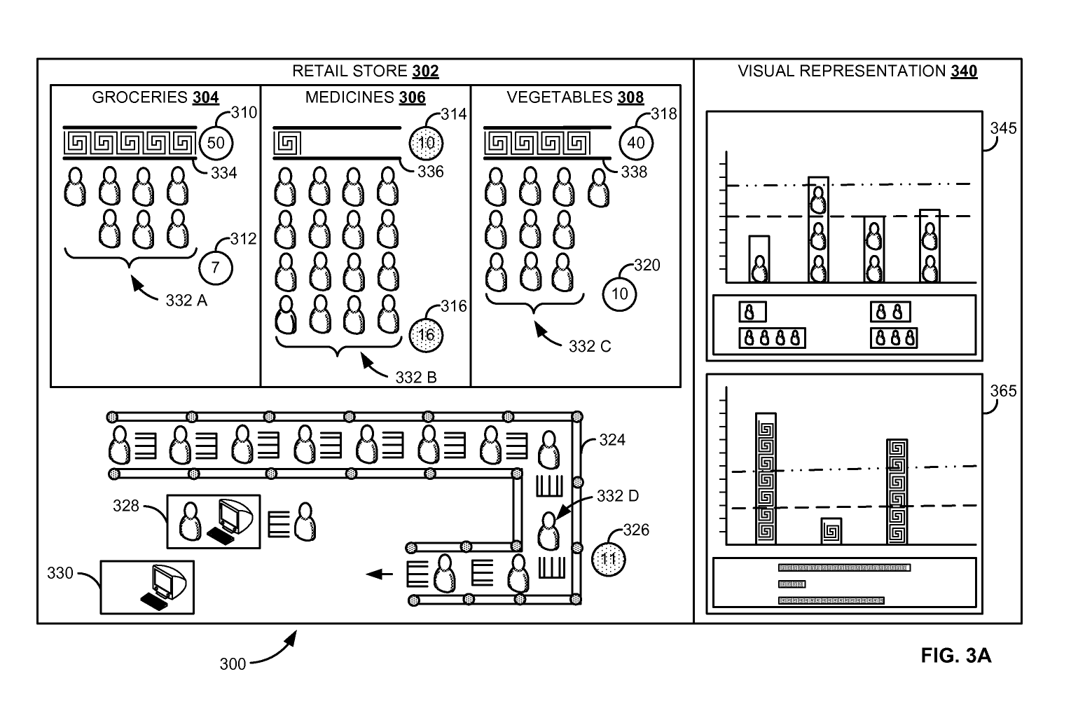

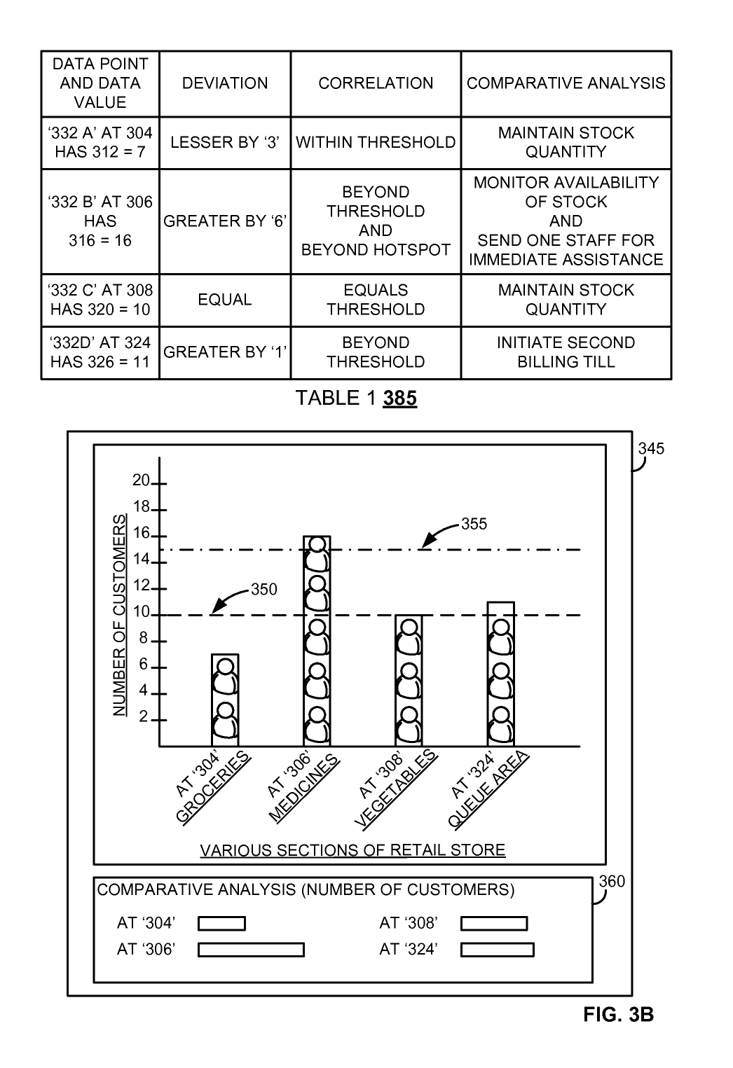

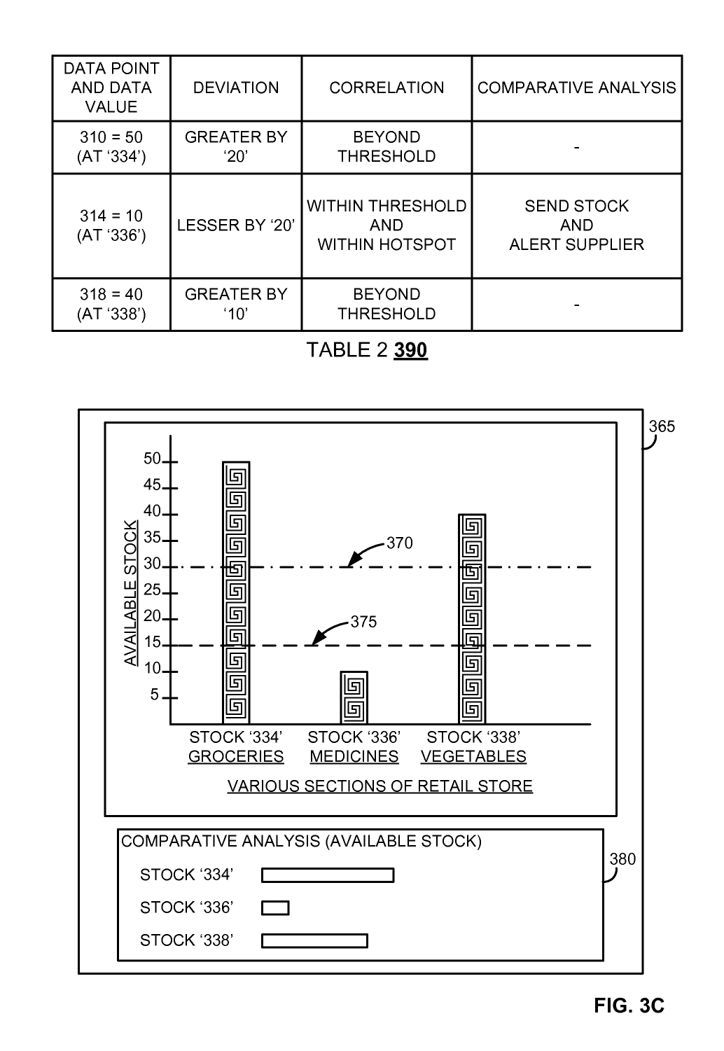

FIG. 3A is a graphical user interface illustrating a business case of a method to generate a visual representation of spatial information of business entities in an enterprise, according to an embodiment. FIGS. 3B and 3C illustrate the visual representation generated on the graphical user interface, according to an embodiment. in an embodiment, the visual representation is generated by the framework. Graphical user interface (GUI) 300 illustrates visual representation section 340, customers 332 (332A, 332B, 332C and 332 D) portraying the business entities, retail store 302 portraying the enterprise, and elements 304, 306 and 308 (groceries, medicines and vegetables) portraying various sections of the enterprise. In an embodiment, GUI 300 is in communication with a motion capturing device and a computer, to display any captured information. For instance, a camera may capture motion information of customers 332 in retail store 302 and a user interface generated by the computer my display the captured information. In an embodiment, the motion information of customers 332 is captured in real-time and rendered on the computer generated GUI 300.

The retail store 302 along with various sections (304, 306, 308, and 324) and the business entities (332A, 332B, 332C, 332D, 334, 336, and 338) are captured (e.g. by a camera) and displayed on GUI 300. The captured information includes spatial information of customers 332 (332A, 332B, 332C and 332D) at any given instance. In an embodiment, a processor may identify the spatial information present in the captured information. A database in communication with the computer generated GUI 300 stores the spatial information at regular intervals. The spatial information includes location and movement information of customers 332 (332A, 332B, 332C and 332D). For instance, seven customers 332A are located at groceries section 304; sixteen customers 332B are located at medicines section 306, eight customers 332C are located at vegetables section 308 and eight customers 332D are located at queue area 324. Further, if one or more of the seven customers 332A move from groceries section 304 to medicines section 306, the movement of such customers is captured.

The spatial information of customers 332A, 332B, 332C and 332D are captured and transformed into corresponding spatial coordinates 312, 316, 320 and 326. The spatial coordinates (312, 316, 320 and 326) include positional values of customers 332A, 332B, 332C and 332D at various instances of time. For example, at a given instance, spatial coordinate 312 has a positional value ‘7’ indicating a number of customers in groceries section 304; spatial coordinate 316 has a positional value ‘16’ indicating a number of customers in medicines section 306; spatial coordinate 320 has a positional value ‘10’ indicating a number of customers in vegetables section 308; and spatial coordinate 326 has a positional value ‘8’ indicating a number of customers waiting in queue area 324. The positional values denote a statistical representation of the location and movement of customers 332A, 332B, 332C and 332D. In an embodiment, spatial coordinates 312, 316, 320 and 326 are associated with time-stamps, indicating a time at which the corresponding spatial information was transformed into spatial coordinates. Based upon the time-stamps, a historical data set including the spatial coordinates of customers 332 (332A, 332B, 332C and 332D) for a period of time may be rendered. Spatial coordinates 312, 316, 320 and 326 may be mapped to corresponding customers 332A, 332B, 332C and 332D and rendered on GUI 300.

Certain business conditions and business logic may be associated with retail store 302. The business condition associated with customers 332 for retail store 302 includes a customer threshold value ‘10’ and a customer threshold drift ‘15’. The associated business logic for retail store 302 includes action ‘MONITOR AVAILABILITY OF STOCK’ to be executed for a positional value higher than the customer threshold value and action ‘SEND ONE STAFF FOR IMMEDIATE ASSISTANCE’ for a positional value higher than the customer threshold drift. The business logic may also include action ‘CHECK STOCK QUALITY’ to be executed for positional value that is comparatively very low when compared to the customer threshold value; action ‘MAINTAIN STOCK QUANTITY’ to be executed for positional values that have remained around the customer threshold value; action ‘INITIATE SECOND BILLING TILL’ to be executed for positional values higher than the customer threshold values and the like.

A deviation is computed by comparing the positional values of spatial coordinates 312, 316, 320 and 326 with the values associated with the business condition. In an embodiment, the deviation from customer threshold drift 316 may be highlighted on user interface 300 for immediate attention. Based upon the deviation, a correlation between the business logic and spatial coordinates 312, 316, 320 and 326 is determined. Based upon the correlation, a comparative analysis is performed to examine a manner of deviation, and the relation between spatial coordinates 312, 316, 320 and 326 and customers 332A, 332B, 332C and 332D. As a result of the comparative analysis, a set of business actions may be generated representing a type of action to be taken to negate the deviation.

The deviation, the correlation and the comparative analysis may be illustrated by Table 1 385 in FIG. 3B. The first column in Table 1 385 illustrates customers at a section of the retail store having a spatial coordinate and a positional value. For instance, the first entry of the first column in Table 1 385 illustrates customers 332A at groceries section 304 having spatial coordinate 312 equal to positional value ‘7’. The second column in Table 1 385 illustrates the deviation between the positional value and the values (threshold value and threshold drift) included in the business condition. The third column in Table 1 385 represents the correlation and the fourth column represents the comparative analysis.

Based upon the analysis, visual representation 340 of the spatial information of customers 332A, 332B, 332C and 332D is generated to establish a business decision. For instance, graph 345 represents the number of customers visiting groceries section 304, medicines section 306 and vegetables section 308. The x-axis of the graph indicates the various sections of retail store 302, including groceries section 304, medicines section 306, vegetables section 308 and queue area 324. The y-axis indicates the number of customers at the respective sections. Elements 355 and 350 indicate the threshold value and the threshold drift configured for customers 332 (332A, 332B, 332C and 332D). Element 360 indicates the comparative analysis. Thus, representing the spatial information of moving business entities (customers 332A, 332B, 332C, and 332D) in a perceivable manner (graph 345) may be useful to establish real-time business decisions in enterprise resource planning systems.

Similarly, the captured information includes spatial information of groceries stock 334, medicines stock 336 and vegetables stock 338 at any given instance. The database in communication with the computer generated GUI 300 stores the spatial information at regular intervals. The spatial information includes location and movement information of groceries stock 334, medicines stock 336 and vegetables stock 338. For instance, fifty grocery items 310 are located at groceries stock 334, ten medicine items 314 are located at medicines stock 336 and forty vegetable bags 318 are located at vegetable stock 338. Further, if one or more of the grocery items is carried away from groceries stock 334, the movement of the items is captured.

The spatial information of groceries stock 334, medicines stock 336 and vegetables stock 338 are captured and transformed into corresponding spatial coordinates 310, 314 and 318. The spatial coordinates 310, 314 and 318 include positional values of groceries stock 334, medicines stock 336 and vegetables stock 338 at various instances. The business conditions associated with the groceries stock 334, medicines stock 336 and vegetables stock 338 for retail store 302 include a stock threshold value ‘30’ and a stock hotspot ‘15’. The associated business logic includes action ‘SEND STOCK’ to be executed for a positional value lower than the stock threshold value and action ‘ALERT SUPPLIER’ to be executed for positional values lower than the stock hotspot.

A deviation is computed by comparing the positional values of spatial coordinates 310, 314 and 318 with values associated with the business condition. Based upon the deviation, a correlation between the business logic and spatial coordinates 310, 314 and 318 is determined. Based upon the correlation, a comparative analysis is performed to examine a manner of deviation, and the relation between spatial coordinates 310, 314 and 318 and groceries stock 334, medicines stock 336 and vegetables stock 338. As a result of the comparative analysis, a set of business actions may be generated representing a type of action to be taken to negate the deviation. The deviation, the correlation and the comparative analysis may be illustrated by Table 2 390 in FIG. 3C.

Based upon the analysis, visual representation 340 of the spatial information of groceries stock 334, medicines stock 336 and vegetables stock 338 is generated to establish a business decision. Since the spatial information is being represented visually, a real-time business decision may be established for circumstances where immediate attention is needed; and by recording the spatial information for a period of time, various other types of business decisions may be established. For example, a medicine supplier may be informed about the medicine item with highest sales in order to maintain the availability of medicine stock 336. Similarly, a billing staff may be informed to initiate a new billing till in order to accommodate the number of customers in queue area 324.

For instance, graph 365 represents the available stock, including groceries stock 334, medicines stock 336 and vegetables stock 338. The x-axis of the graph indicates the various sections of retail store 302, including groceries section 304, medicines section 306, vegetables section 308 and queue area 324. The y-axis indicates the availability of the stock at the respective sections. Elements 370 and 375 indicate the threshold value and the threshold drift configured for groceries stock 334, medicines stock 336 and vegetables stock 338. Element 380 indicates the comparative analysis. Thus, representing the spatial information of moving business entities (items in groceries stock 334, medicines stock 336 and vegetables stock 338) in a perceivable manner (graph 365) may be useful to establish real-time business decisions in enterprise resource planning systems. Such visual representation may be helpful to establish medical alerts in a hospital, safety alerts, and the like. Such representation may also be useful to understand a market and regulate the production and supply of goods and/or services.

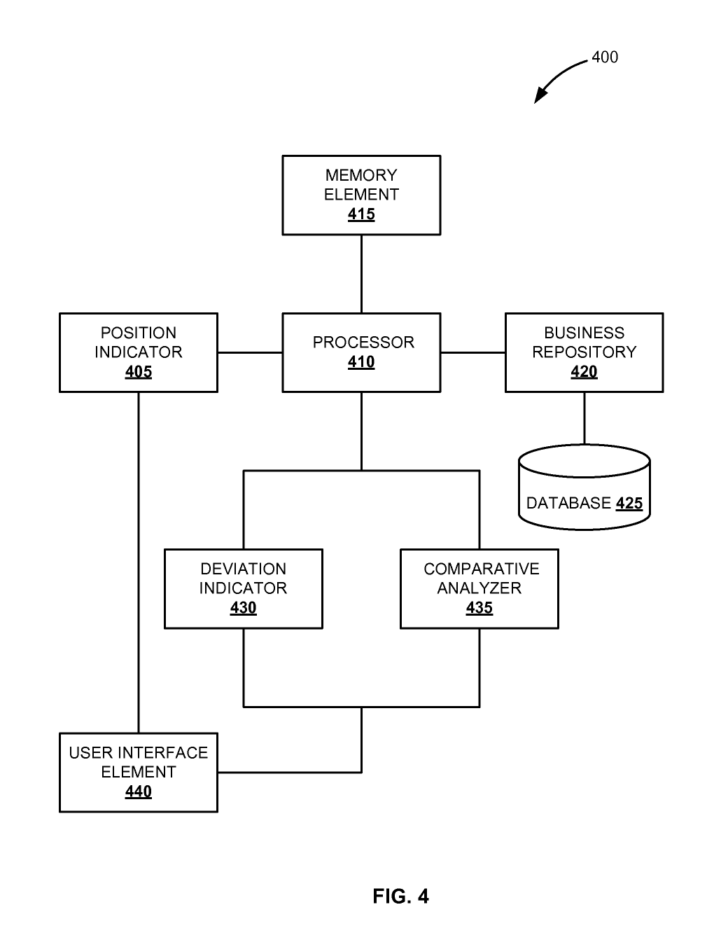

FIG. 4 is a block diagram illustrating a computer system to generate a visual representation of spatial information of business entities in an enterprise, according to an embodiment. Computer system 400 includes position indicator 405, user interface element 440, memory element 415, processor 410, business repository 420, database 425, deviation indicator 430 and comparative analyzer 435. In an embodiment, position indicator 405 is in communication with user interface element 440 and processor 410. Processor 410 is in communication with memory element 415, business repository 420, deviation indicator 430, and comparative analyzer 435. Business repository 420 is in communication with database 425. User interface element 440 is in communication with 430 and comparative analyzer 435.

Memory element 415 stores instructions to generate the visual representation of spatial information. Processor 410 is configured to read and execute the instructions stored in memory element 415. In an embodiment, a motion-capturing engine may capture the motion of the business entities in the enterprise; and a computer generated user interface associated with user interface element 440 may render the captured motion on the user interface. For instance, a camera may capture the movement of store-staff in a store; and a computer monitor may render the captured motion information on a computer screen. Thus, a user may view the movement of the store-staff on the computer screen. In an embodiment, the motion is captured in real-time, and rendered on the user interface.

Position indicator 405 captures spatial information of the business entities from the captured motion of the business entities. Processor 410 transforms the spatial information to spatial coordinates. The spatial coordinates include positional values of the business entities at various instances of time. Transforming the spatial information into spatial coordinates include identifying a location and a movement of each business entity and generating a statistical representation of the location and the movement. In an embodiment, the location and movement information of the business entities are persisted in database 425 along with time-stamps. Time-stamps indicate a time at which the spatial information is captured. In an embodiment, at any given instance, a historical data set may be generated based upon the spatial information and the corresponding time-stamps stored in database 425. The historical data set may render the spatial information of the business entities over a period of time. In an embodiment, the spatial coordinates may be mapped to corresponding business entities and rendered on the user interface.

Business repository 420 stores metadata associated with the business entities and the enterprise. The metadata may include business conditions, business logic and any other information that may be associated with the business entities and the enterprise in which they (business entities) exist. The business condition may include threshold values indicating acceptable values for the business entities and the enterprise. The business condition may also include threshold drifts that denote unacceptable values or require immediate attention. The business logic may describe principles or algorithms to handle the business entities within the enterprise. The business logic may comprise one or more business actions to be taken for corresponding deviations that are computed based upon the business conditions. Business logic may also include instructions to perform one or more functions associated with generating the visual representation.

Based upon the business condition associated with for the business entities, processor 410 processes the spatial coordinates. Deviation indicator 430 computes a deviation by comparing the positional values of the spatial coordinates and the values associated with the business conditions. User interface element 440 may render a visual representation of the spatial coordinates indicating the deviation of the positional values associated with the spatial coordinates from the threshold value. Based upon the deviation, a correlation between the business logic and the spatial coordinates is determined by deviation indicator 430. In an embodiment, deviation indicator 430 indicates an immediate action for a threshold drift which is an unacceptable deviation from the threshold value. To determine a correlation, processor 410 derives a relation between the spatial coordinates and the business entities. Based upon the relation, deviation indicator 430 identifies a significance of the relation and derives a business scope for the spatial coordinates. The business scope may describe an assessment of actions to be taken on the spatial coordinates and the business entities. Based upon the correlation, comparative analyzer 435 performs a comparative analysis of the spatial coordinates to examine the manner of deviation, and the relation and significance between the spatial coordinates and the business entities. As a result of the analysis, a set of business actions may be generated, representing a type of action to be taken to negate the deviation. Based upon the analysis, comparative analyzer 435 generates a visual representation of the spatial information of the business entities. User interface element 440 renders the generated visual representation on the user interface to establish business decisions.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

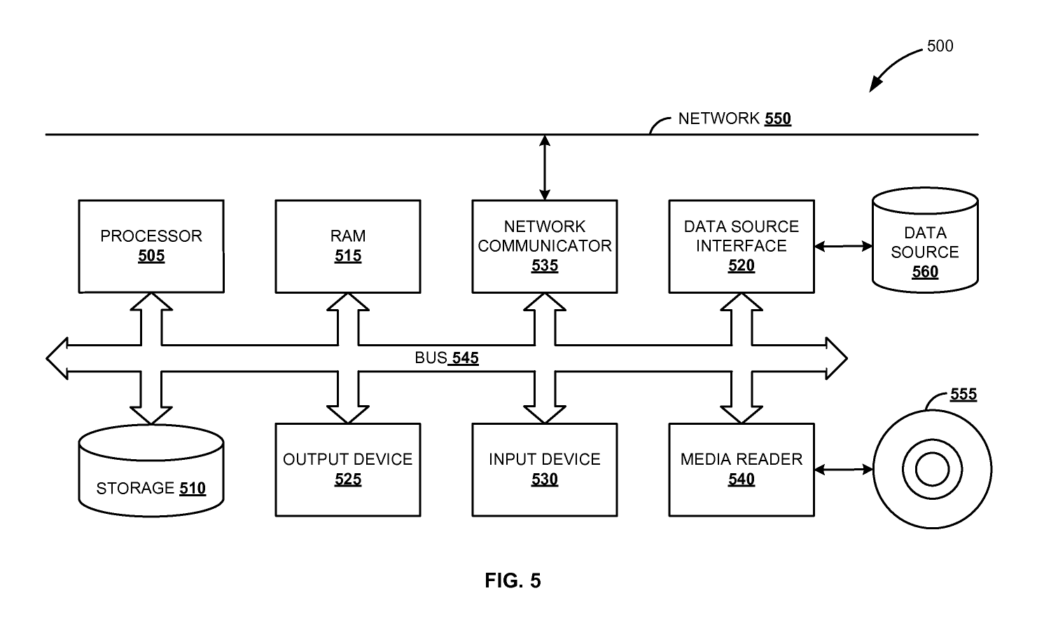

FIG. 5 is a block diagram of an exemplary computer system 500. The computer system 500 includes a processor 505 that executes software instructions or code stored on a computer readable storage medium 555 to perform the above-illustrated methods of the invention. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. The stored instructions may be further compiled to generate other representations of the instructions and dynamically stored in the RAM 515. The processor 505 reads instructions from the RAM 515 and performs actions as instructed. According to one embodiment of the invention, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, continuation servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. A computer implemented method to generate a framework to render spatial information of one or more business entities in an enterprise, comprising:
a processor of the computer transforming the spatial information of the business entities to corresponding spatial coordinates;
based upon a business condition associated with the business entities, the processor processing the spatial coordinates to compute a deviation;
based upon the deviation, the processor determining a correlation between a business logic associated with the business entities and the spatial coordinates; and
based upon the correlation, generating the framework to render a visual representation of the spatial information, to establish a business decision.

2. The computer implemented method of claim 1 further comprising: capturing spatial information of the business entities.

3. The computer implemented method of claim 1 further comprising:
determining the business condition and the business logic associated with the business entities;
based upon the business condition and the business logic, generating a correlation framework to
transform a received spatial information into corresponding spatial coordinates;
compute a deviation between the spatial coordinates and the business condition;
based upon the deviation, determine a correlation between the business logic and the spatial coordinates; and
render a visual representation including the correlation, to establish the business decision.

4. The computer implemented method of claim 1, wherein the spatial coordinates comprise one or more positional values of each business entity at a corresponding instance.

5. The computer implemented method of claim 1, wherein transforming the spatial information to the spatial coordinates comprise:
identifying a location of the business entities in the enterprise;
identifying a movement of the business entities; and
generating the spatial coordinates including a statistical representation of the location and the movement of the business entities.

6. The computer implemented method of claim 5, wherein the location and the movement of the business entities are persisted in a database along with corresponding time-stamps.

7. The computer implemented method of claim 5 further comprising: generating a historical data set based upon the information and time-stamps persisted in the database, wherein the historical data set renders the spatial information of the business entities over a period of time.

8. The computer implemented method of claim 1, wherein processing the spatial coordinates comprise:
identifying a positional value associated with each spatial coordinate; and
comparing the positional value with values associated with the business condition to determine the deviation.

9. The computer implemented method of claim 1 further comprising: mapping the spatial coordinates corresponding to the business entities on a computer generated user interface.

10. The computer implemented method of claim 1, wherein the business condition comprises: a threshold value indicating one or more actions to be executed based upon a deviation of the spatial information from the threshold value.

11. The computer implemented method of claim 1, wherein the business condition comprises: a threshold drift indicating one or more actions to be executed immediately based upon a deviation of the spatial information from the threshold value.

12. The computer implemented method of claim 9, wherein the computer generated user interface comprises: a visual representation of the spatial coordinates indicating the deviation of the values associated with the spatial coordinates from the threshold value.

13. The computer implemented method of claim 1, wherein the business logic associated with the business entities comprise instructions:
to derive a relation between the spatial coordinates and the business entities;
based upon the enterprise, to identify a significance of the relation, and
based upon the significance, to derive a business scope for the spatial coordinates.

14. The computer implemented method of claim 1, wherein determining the correlation comprises: determining the relation and the corresponding significance between the spatial coordinates and the business entities.

15. The computer implemented method of claim 1, wherein the framework configures the computer generated user interface to render a visual representation of the spatial coordinates, the correlation between the spatial coordinates, and the historical data.

16. The computer implemented method of claim 1, wherein the framework executes a comparative analysis of the spatial coordinates to render a visual representation of the correlation between the business logic and the spatial coordinates.

17. An article of manufacture including a computer readable storage medium to tangibly store instructions, which when executed by a computer, cause the computer to:
transform spatial information of business entities to corresponding spatial coordinates;
based upon a business condition associated with the business entities, process the spatial coordinates to compute a deviation;
based upon the deviation, determine a correlation between a business logic associated with the business entities and the spatial coordinates; and
based upon the correlation, render a visual representation of the spatial information, to establish a business decision.

18. A computer system to generate a framework to render spatial information of one or more business entities in an enterprise, comprising:
a processor to read and execute instructions stored in one or more memory elements; and
the one or more memory elements storing instructions to:
a position indicator to capture the spatial information of the business entities;
the processor to transform the spatial information to one or more corresponding spatial coordinates;
a business repository to store one or more business conditions and one or more business logic corresponding to the business entities;
a deviation indicator to process the spatial coordinates and compute a deviation based upon the business conditions associated with the business entities;
the processor to determine a correlation between the business logic associated with the business entities and the spatial coordinates based upon the deviation; and
a computer generated user interface element to generate a framework to render a visual representation of the spatial information of the business entities and establish a business decision, based upon the correlation.

19. The computer system of claim 18 further comprising: an analyzer to comparatively analyze the correlation between the business logic, the spatial coordinates and associated time-stamps.

20. The computer system of claim 18 further comprising: a database to
persist movement and location information of the business entities along with corresponding time-stamps; and
generate a historical data set based upon the persisted information over a period of time.
